(19) United States
(12) Patent Application Publication
(10) Pub. No.: US 2016/0262298 A1
(43) Pub. Date: Sep. 15, 2016

(54) Rock Collecting Apparatus

(71) Applicant: Douglas Dean Anderson, Marshall, MN (US)

(72) Inventor: Douglas Dean Anderson, Marshall, MN (US)

(21) Appl. No.: 14/657,542

(22) Filed: Mar. 13, 2015

(51) Int. Cl. A01B 43/00

(52) U.S. Cl. CPC A01B 43/00

(57) ABSTRACT

A rock collecting apparatus includes a frame that has a front side, a back side, a first lateral side and a second lateral side. A pair of wheels is rotatably attached to the frame. A housing for receiving and carrying a plurality of rocks is mounted on the frame. A hitch connector is coupled to the frame and a rake is pivotally coupled to the frame adjacent to the front side. The rake engages rocks such that the rocks are moved upwardly into the housing. The rake is positionable in a deployed position positioned adjacent to the ground surface or in a stored position spaced from the ground surface. A shovel is rotatably mounted to the rake and moves rocks up the rake and into the housing.

### BACKGROUND OF THE DISCLOSURE

### Field of the Disclosure

The disclosure relates to rock picking devices and more particularly pertains to a new rock picking device for being pulled along a ground surface such that rocks positioned on or in the ground surface are picked up by the device for movement to another area.

### SUMMARY OF THE DISCLOSURE

An embodiment of the disclosure meets the needs presented above by generally comprising a frame that has a front side, a back side, a first lateral side and a second lateral side. A pair of wheels is rotatably attached to the frame. A housing for receiving and carrying a plurality of rocks is mounted on the frame. A hitch connector attached to the frame has a free end positioned distal to the housing and an attached end positioned proximal to the housing. A rake is pivotally coupled to the frame adjacent to the front side. The rake engages rocks such that the rocks are moved upwardly into the housing. The rake has a distal end and a proximal end relative to the housing. The rake is positionable in a deployed position positioned adjacent to or below and engaging the ground surface or in a stored position vertically spaced from the ground surface. A lift mechanism is attached to the rake and is actuated to selectively move the rake between the stored and the deployed positions. A shovel is rotatably mounted to the rake and moves rocks up the rake and into the housing. A drive assembly is mechanically coupled to the shovel and is turned on to rotate the shovel relative to the rake.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a rock collecting apparatus according to an embodiment of the disclosure.

FIG. 2 is a bottom perspective view of an embodiment of the disclosure.

FIG. 3 is a top view of an embodiment of the disclosure.

FIG. 4 is a bottom view of an embodiment of the disclosure.

FIG. 5 is a front view of an embodiment of the disclosure.

FIG. 6 is a broken side view of an embodiment of the disclosure broken along line 6-6 of FIG. 5.

FIG. 7 is a side in-use view of an embodiment of the disclosure.

FIG. 8 is a top perspective view of an embodiment of the disclosure.

FIG. 9 is a side view of an embodiment of the disclosure.

FIG. 10 is box diagram view of an embodiment of the disclosure.

### DESCRIPTION OF THE PREFERRED EMBODIMENT

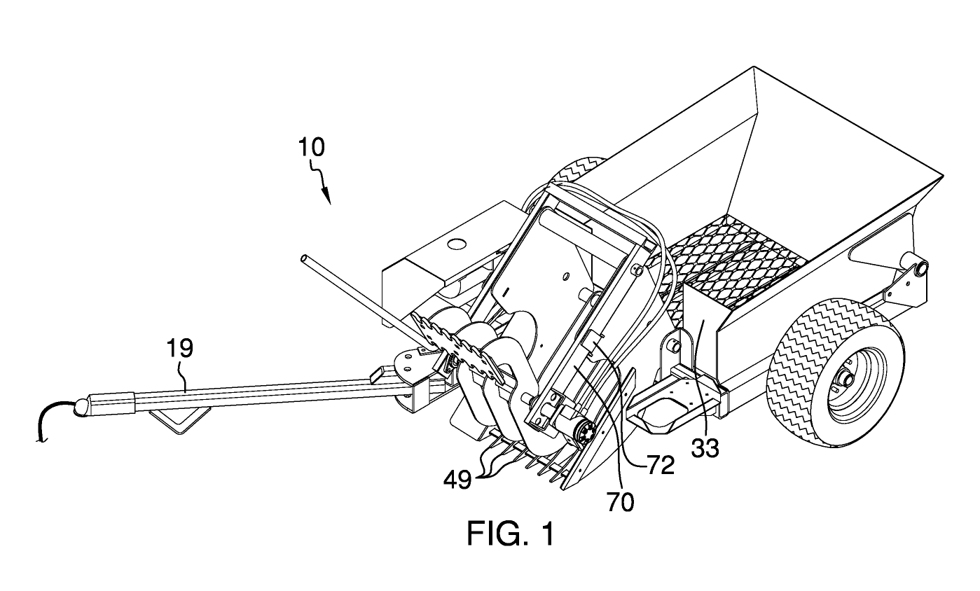

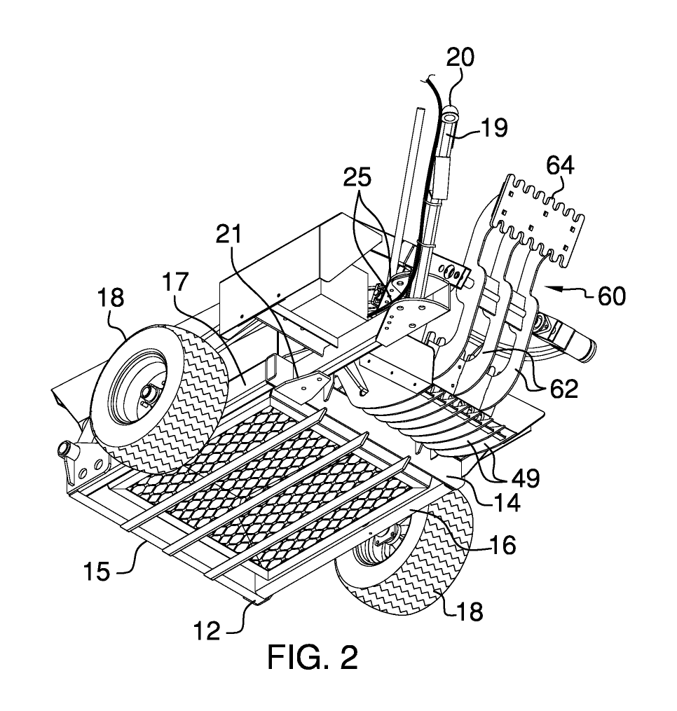

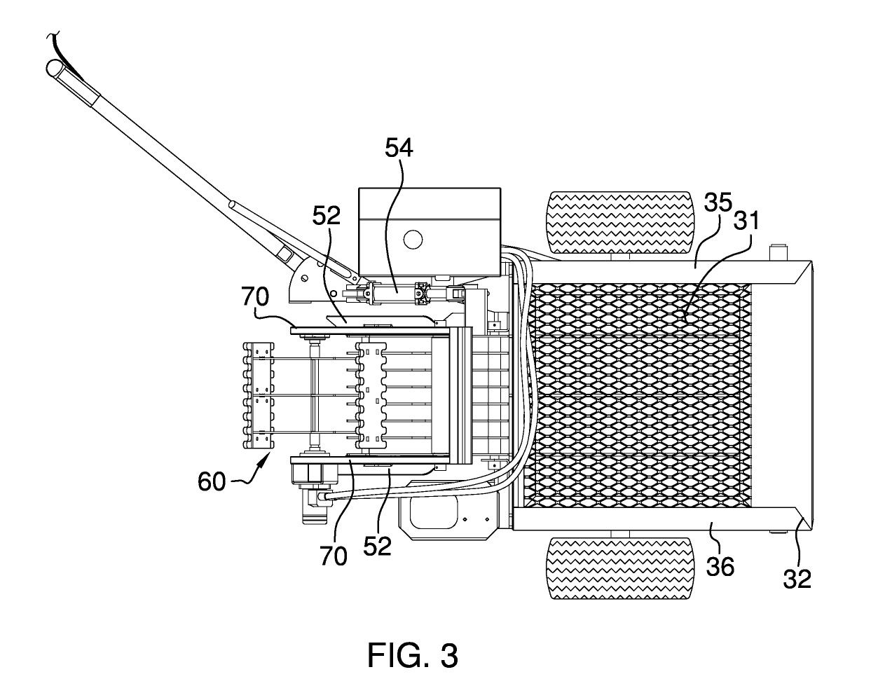

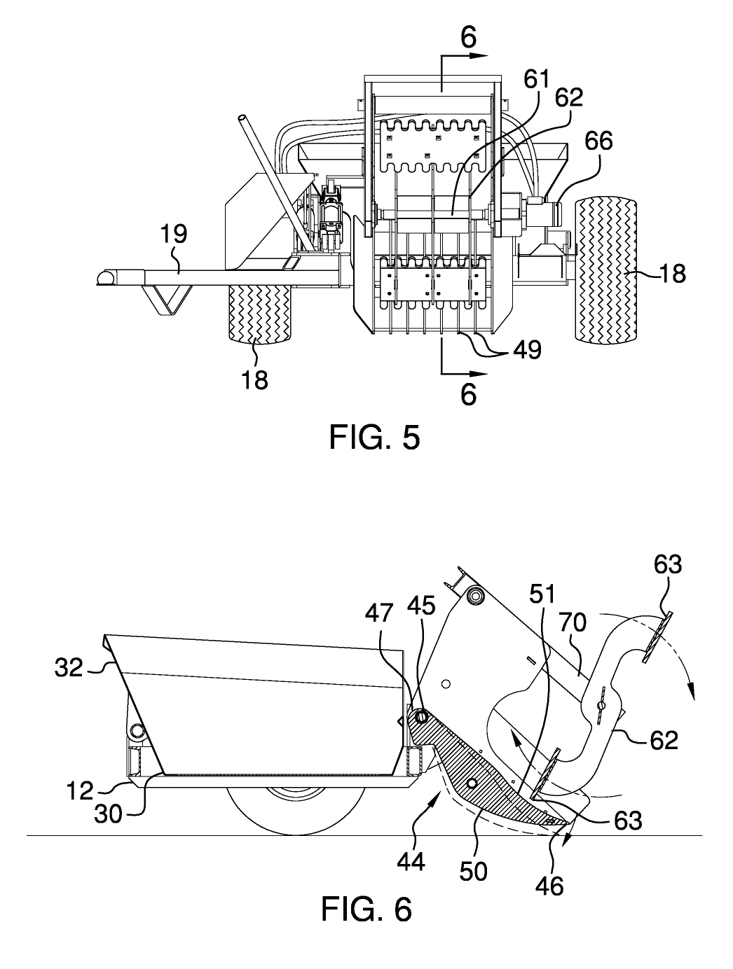

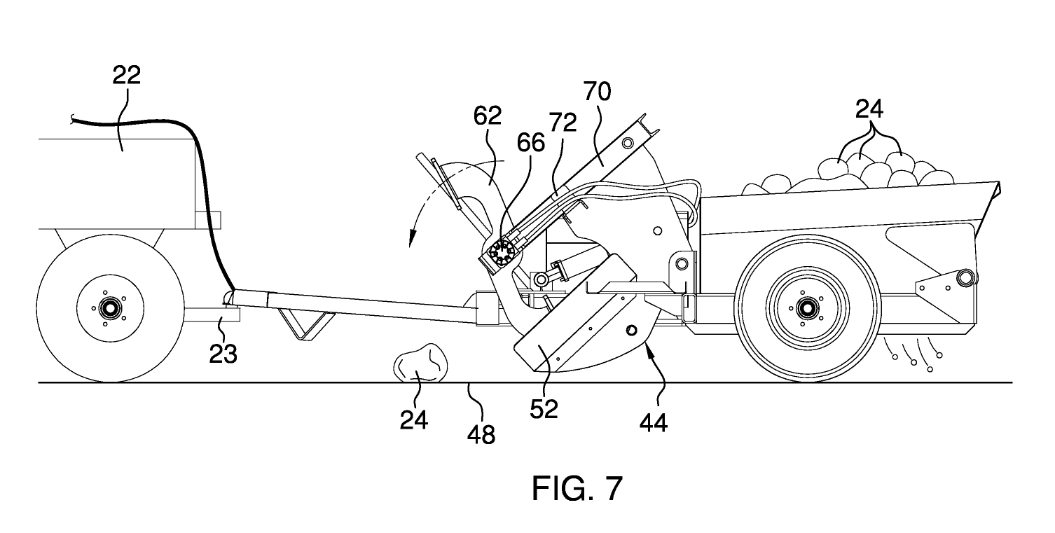

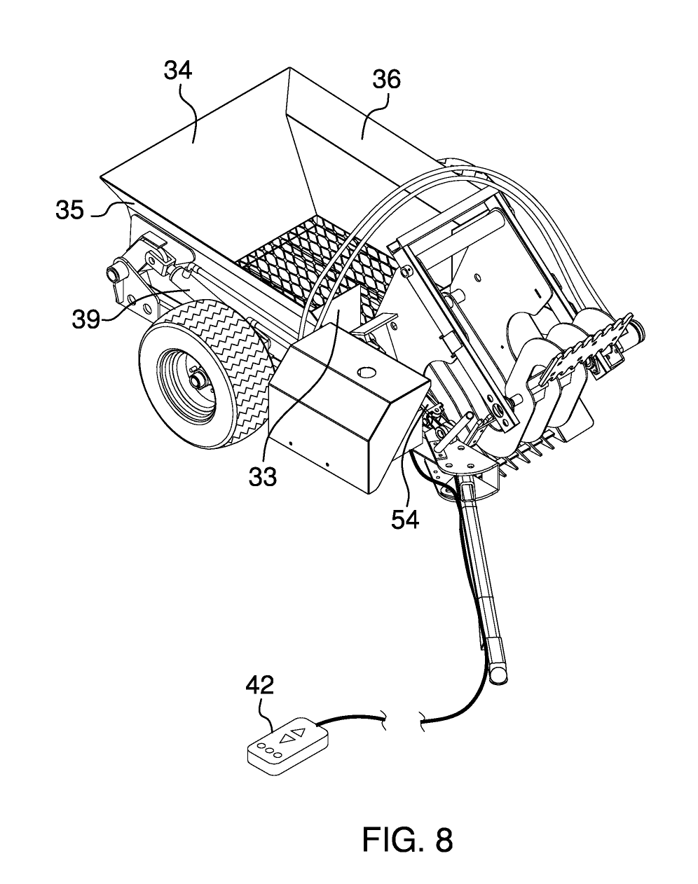

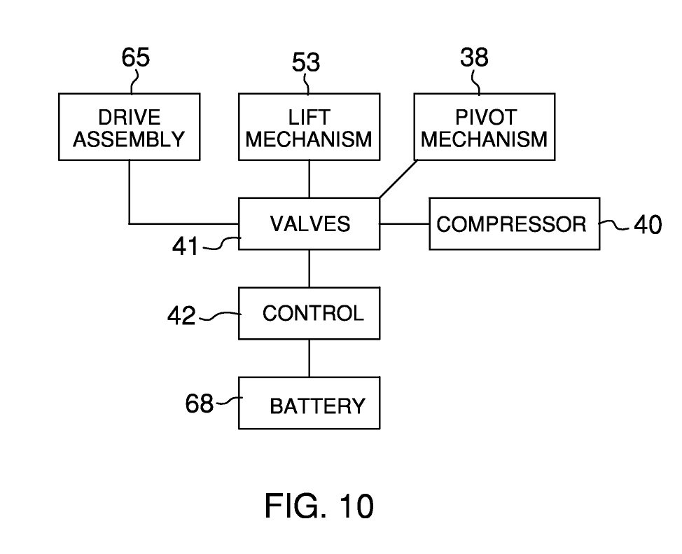

With reference now to the drawings, and in particular to FIGS. 1 through 10 thereof, a new rock picking device embodying the principles and concepts of an embodiment of the disclosure and generally designated by the reference numeral 10 will be described.

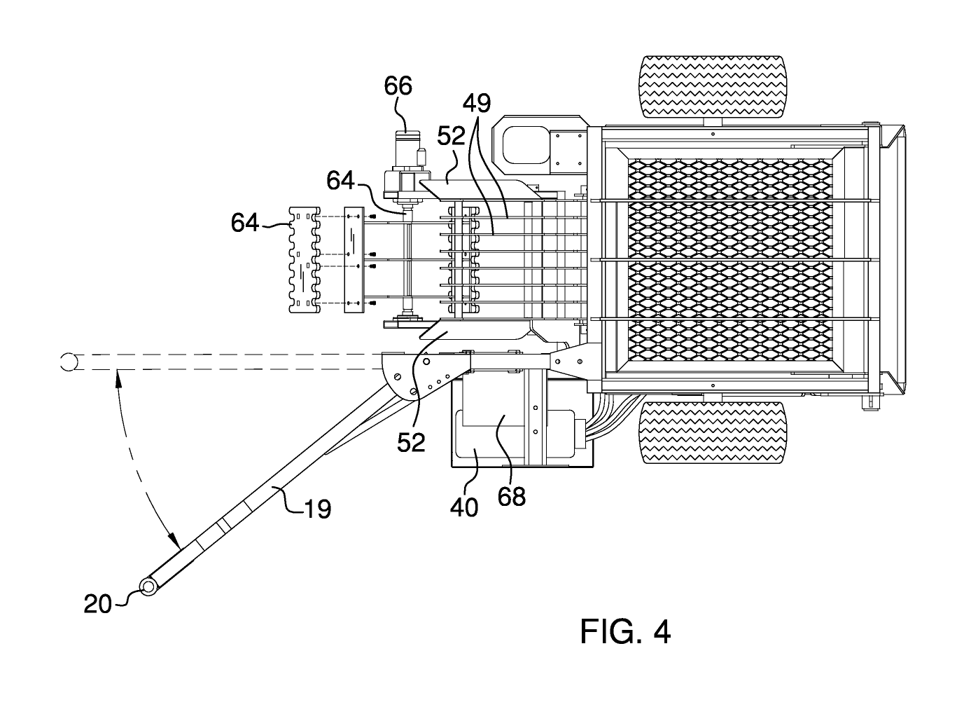

As best illustrated in FIGS. 1 through 10, the rock collecting apparatus 10 generally comprises a frame 12 with a front side 14, a back side 15, a first lateral side 16 and a second lateral side 17. A pair of wheels 18 is rotatably attached to the frame 12 wherein each of the first 16 and second 17 lateral sides has one of the wheels 18 positioned adjacent thereto. A hitch connector 19 is attached to the frame 12 and has a free end 20 positioned distal to the frame 12 and an attached end 21 positioned proximal to the frame 12. The free end 20 may be comprised of a conventional hitch receiver that may be mounted on an all-terrain vehicle 22. The attached end 21 is positioned nearer to the first lateral side 16 than the second lateral side 17, though this may be reversed. The attached end 21 is pivotally coupled to the frame 12 so that the free end 20 is movable laterally away from a longitudinal axis the first lateral side 16 such that the frame is configured to be offset from a trailer hitch 23 pulling the frame 12. Thus, when the hitch connector 19, which is elongated, is extending directly forward of the frame 12, the frame will be positioned generally behind the all-terrain vehicle 22. However, when the apparatus 10 is being used to pick rocks 24, the hitch connector 19 will be angled laterally away from the frame 12 as shown in FIG. 4 to place the frame 12 such that it is not behind the all-terrain vehicle 22. The hitch connector 19 may be locked in a selected position relative the frame 12 in any conventional manner such as a pin positionable in aligned apertures 25.

A housing 30, or bucket, is provided which is configured to receive and carry a plurality of rocks 24. The housing 30 is pivotally mounted on the frame 12. The housing 30 includes a bottom wall 31 and a perimeter wall 32 that is attached to and extends upwardly from the bottom wall 31. A front wall 33 of the housing 30 is substantially open or may include a large notch therein for allowing rocks to pass through the perimeter wall 32. The perimeter wall 32 further includes a rear wall 34, and a first lateral wall 35 and a second lateral wall 36. The bottom wall 31 has a plurality of openings therein configured to allow debris smaller than a predetermined size to fall through the bottom wall 31. As can be seen in the Figures, the bottom wall 31 may comprise a mesh material with openings having a greatest diameter being less than 2.5 inches. The housing 30 is pivotable adjacent to a juncture of the bottom wall 31 and the rear wall 34 such that the front wall 33 is lifted upwardly away from the frame 12 when the housing 30 pivots relative to the frame 12. This movement will dump rocks 24 outwardly over the rear wall 34 as the housing 30 is tilted rearwards. The rear wall 34 may be angled rearward from the bottom wall 31 to a top of the rear wall 34 to facilitate the dumping of the rocks 24 therefrom.

A pivot mechanism 38 is attached to the frame 12 and to the housing 30. The pivot mechanism 38 is actuated to move the housing 30 to a fill position having the housing 30 in a generally horizontal orientation or to a dump position with the housing 30 is tilted rearward from the frame 12. The pivot mechanism 38 may include a bucket piston 39, which is hydraulically actuated, coupled to the frame 12 and to the housing 30. The bucket piston 39 is fluidly coupled to a compressor 40. Valves 41 are operationally coupled to a control 42 for allowing fluid from the compressor 40 to move the hydraulic piston. While the apparatus 10 generally utilizes compressed fluid for operations herein and below, it should be understood that pneumatic actuation or electric motors may be utilized instead.

A rake 44 is pivotally coupled to the frame 12 adjacent to the front side 14 by a pivot rod 45, wherein the frame 12 may be considered as including additional walls for attachment thereto as can be seen in the Figures, though the rake could instead be coupled to the housing 30. The rake 44 is configured to engage rocks 24 such that the rocks 24 are moved upwardly into the housing 30. The rake 44 has a distal end 46 and a proximal end 47 relative to the housing 30 and the rake 44 is angled upwardly from the distal end 46 to the proximal end 47 such that rocks 24 move up the rake 44 and into the housing 30. The rake 44 is positionable in a deployed position that is positioned adjacent to or below and engaging a ground surface 48 or in a stored position vertically spaced from and above the ground surface 48. However, the rake 44 may remain in a downward angle even in the stored, fully lifted position. The rake 44 may be selectively positionable between the deployed and stored positions. More particularly, the rake 44 may be moved to a position directly adjacent to the ground surface 48 or up to 6.0 inches below the ground surface 48. Thus the rake 44 may pull rocks 24 upwardly which are extending into or slightly below the ground surface 48. The rake 44 may include a plurality of spaced plates 49 extending from the proximal end 47 to the distal end 46. The plates 49 each lie in vertically oriented planes that are oriented parallel to each other. The plates 49 are spaced from each other a distance of between 1.0 inches and 4.0 inches to allow soil and smaller particles and rocks to flow through the rake 44. The distal ends 46 are pointed and the plates 49 each have a bottom surface 50 which is convexly arcuate. The plates 49 may have upper surface 51 which is concavely arcuate. A distance from the distal ends 46 of the rake 44 to the back side 15 of the frame 12 is less than 6.0 feet.

A pair of guide walls 52 may be attached to the rake 44. The guide walls 52 are positioned on opposite outer sides of the rake 44 and prevent rocks 24 from falling laterally off of the rake 44 as the rocks 24 move from the distal end 46 to the housing 30. The guide walls 52 flare outwardly as the guide walls 52 extend upwardly from the plates 49.

A lift mechanism 53 is attached to the rake 44. The lift mechanism 53 is actuated to selectively move the rake 44 between the stored and the deployed positions. The lift mechanism 53 may include a hydraulically actuated rake piston 54 attached to the frame 12 and to the rake 44. The rake piston 54 is fluidly coupled to the compressor 40, while conventional valves 41 and the control 42 are used to control the rake piston 54.

A shovel 60 is rotatably mounted to the rake 44 and is configured to move rocks 24 up the rake 44 and into the housing 30. The shovel 60 comprises an axle 61 that is rotatably attached to the rake 44 and traverses the upper surface 51 of the rake 44. An paddle arm 62 is attached to the axle 61 and a pair of opposed ends 63 positioned opposite of each other are each located distal to the axle 61. As can be seen in FIG. 1, the paddle arm 62 may comprise a plurality of paddle arms 62. Each of the opposed ends 63 is movably along and adjacent to the plates 49 as the axle 61 is rotated relative to the rake 44. The opposed ends 63 are configured to engage rocks 24 and move the rocks 24 along the plates 49 and into the housing 30. Each of the opposed ends 63 has a plurality of teeth 64 attached thereto. The teeth 64 may be removably mounted to the paddle arm 62 for the purpose of facilitating replacement of the teeth 64. A drive assembly 65 is mechanically coupled to the shovel 60 and is turned on to rotate the shovel 60 relative to the rake 44. The drive assembly 65 may include a motor 66 which is hydraulically powered and fluidly coupled to the compressor 40. The drive assembly 65 is operationally coupled to the control 42 so that the control 42 may be used to selectively rotate the axle 61 as needed. As should be understood from the above, since the shovel 60 is coupled to the rake 44, the shovel 60 may engage the ground surface 48 to pull rocks 24 upwardly out of the ground surface 48.

As can be seen in the Figures, the axle 61 may be attached to a pair of pivot arms 70, which are in turn coupled to opposite sides of the rake 44. The pivot arms 70 are pivotally coupled to the rake 44 which allows the shovel 60, including the axle 61 and paddle arm 62, to lift upwardly relative to the rake 44. When one of the opposed ends 63 engages a rock that becomes lodged against the distal end of the rake 44, the pivot arms 70 permit the shovel 60 to effectively “jump” over rock and prevent a jam between the rake 44 and the shovel 60. The pivot arms 70 are pulled downward by gravity and may be seated in brackets 72 attached to the rake 44 when they are at their lowest point. The pivot arms 70 furthermore prevent damage the shovel 60 should it engage particularly firm areas of ground surface 48.

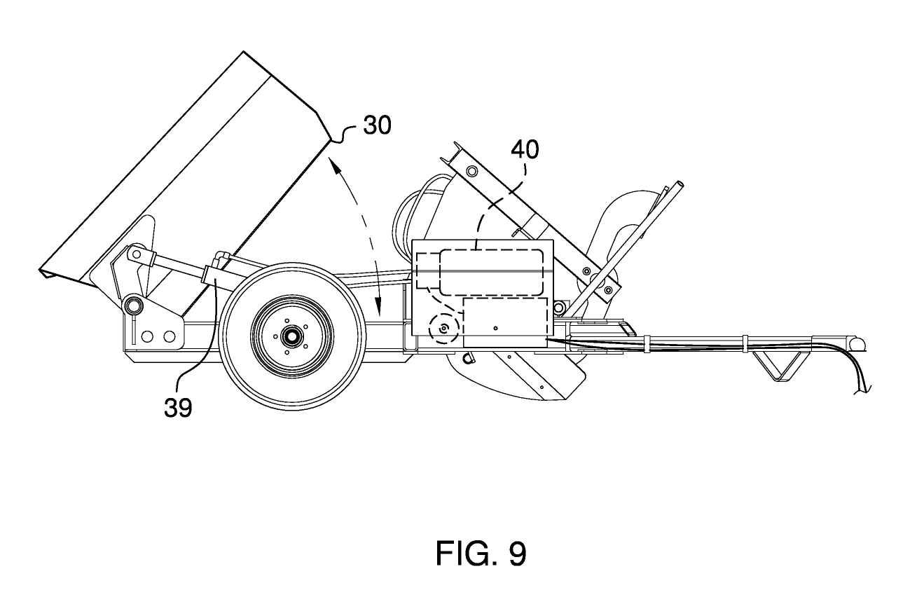

In use, the frame 12 is coupled to an all-terrain vehicle 22, commonly known as a 4-wheeler or quad, with the hitch coupler 19 such that the frame 12 can be pulled along a ground surface 48 where rocks 24 are to be collected. The rake 44 is pivoted downward so that it may engage and cause the rock(s) to move onto the plates 49. If the ground surface 48 is comprised of relatively loose soil, the rake 44 may be tilted so that it extends into the ground surface 48 as well to lift rocks 24 upwardly out of the soil. When rocks 24 are positioned on the rake 44, the shovel 60 is turned on so that as it rotates the rock(s) 24 is moved into the housing 30 for transfer to a different location. Once the housing 30 is full or at the completion of the task, the user will take the housing 30 to an area where the housing 30 can be tilted rearwardly as shown in FIG. 9 to dump the rocks 24 out of the housing 30. A control 42, or control box, operationally coupled to a battery 68 and the valves 41 may is used to move the rake 44, shovel 60 and housing 30 as needed. The battery 68 may be used to power the compressor 40 though any conventional motor may be used as a power source for the apparatus 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rock lifting assembly configured to be coupled to a vehicle and lift and collect rocks off of a ground surface, said assembly comprising:
a frame having a front side, a back side, a first lateral side and a second lateral side;
a pair of wheels being rotatably attached to said frame;
a housing configured to receive and carry a plurality of rocks, said housing being mounted on said frame;
a hitch connector being attached to said frame, said hitch connector having a free end positioned distal to said frame and an attached end positioned proximal to said frame;
a rake being pivotally coupled to said frame adjacent to said front side, said rake being configured to engage rocks such that the rocks are moved upwardly into said housing, said rake having a distal end and a proximal end relative to said housing, said rake being positionable in a deployed position being positioned adjacent to or below and engaging the ground surface or in a stored position vertically spaced from the ground surface;
a lift mechanism being attached to said rake, said lift mechanism being actuated to selectively move said rake between said stored and said deployed positions;
a shovel being rotatably mounted to said rake and being configured to move rocks up said rake and into said housing;
a drive assembly being mechanically coupled to said shovel and being turned on to rotate said shovel relative to said rake.

2. The rock lifting assembly according to claim 1, further including:
said housing being pivotally mounted on said frame, said housing including a bottom wall and a perimeter wall being attached to and extending upwardly from said bottom wall, a front wall of said housing being substantially open, said perimeter wall including a rear wall, and a first lateral wall and a second lateral wall, said housing being pivotable adjacent to a juncture of said bottom wall and said rear wall such that said front wall is lifted upwardly away from said frame when said housing pivots relative to said frame; and
a pivot mechanism being attached to said frame and to said housing, said pivot mechanism being actuated to move said housing to a fill position having said housing a generally horizontal orientation or to a dump position having said housing being tilted rearward from said frame.

3. The rock lifting assembly according to claim 2, wherein said bottom wall has a plurality of openings therein configured to allow debris smaller than a predetermined size to fall through said bottom wall.

4. The rock lifting assembly according to claim 1, wherein said bottom wall has a plurality of openings therein configured to allow debris smaller than a predetermined size to fall through said bottom wall.

5. The rock lifting assembly according to claim 1, wherein said attached end of said hitch connector is positioned nearer to said first lateral side than said second lateral side.

6. The rock lifting assembly according to claim 5, wherein said free end is movable laterally away from a longitudinal axis said first lateral side such that said frame is configured to be offset from a trailer hitch pulling said frame.

7. The rock lifting assembly according to claim 1, wherein said rake includes a plurality of spaced plates extending from said proximal end to said distal end, said plates each lying in a vertically oriented plane and being oriented parallel to each other, said distal ends being pointed.

8. The rock lifting assembly according to claim 7, wherein said plates each have a bottom surface being convexly arcuate.

9. The rock lifting assembly according to claim 7, further including a pair of guide walls being attached to said rake, said guide walls being positioned on opposite outer sides of said rake.

10. The rock lifting assembly according to claim 9, wherein said guide walls flare outwardly as said guide walls extend upwardly from said plates.

11. The rock lifting assembly according to claim 9, wherein said shovel comprises:
an axle being rotatably attached to said rake and traversing an upper surface of said rake;
a paddle arm being attached to said axle, said paddle arm having a pair of opposed ends positioned opposite of each other, each of said opposed ends being movably along said plates as said axle is rotated relative to said rake, said opposed ends being configured to engage rocks and move the rocks along said plates and into said positionable adjacent to said plates as said axle housing.

12. The rock lifting assembly according to claim 11, wherein each of said opposed ends has a plurality of teeth attached thereto.

13. The rock lifting assembly according to claim 7, wherein said shovel comprises:
an axle being rotatably attached to said rake and traversing an upper surface of said rake;
an paddle arm being attached to said axle, said paddle arm having a pair of opposed ends positioned opposite of each other, each of said opposed ends being movably along said plates as said axle is rotated relative to said rake, said opposed ends being configured to engage rocks and move the rocks along said plates and into said positionable adjacent to said plates as said axle housing.

14. The rock lifting assembly according to claim 13, wherein each of said opposed ends has a plurality of teeth attached thereto.

15. A rock lifting assembly configured to be coupled to a vehicle and lift and collect rocks off of a ground surface, said assembly comprising:
a frame having a front side, a back side, a first lateral side and a second lateral side;
a pair of wheels being rotatably attached to said frame, each of said first and second lateral sides having one of said wheels positioned adjacent thereto;
a housing configured to receive and carry a plurality of rocks, said housing being pivotally mounted on said frame, said housing including a bottom wall and a perimeter wall being attached to and extending upwardly from said bottom wall, a front wall of said housing being substantially open, said perimeter wall including a rear wall, and a first lateral wall and a second lateral wall, said bottom wall having a plurality of openings therein configured to allow debris smaller than a predetermined size to fall through said bottom wall, said housing being pivotable adjacent to a juncture of said bottom wall and said rear wall such that said front wall is lifted upwardly away from said frame when said housing pivots relative to said frame;
a pivot mechanism being attached to said frame and to said housing, said pivot mechanism being actuated to move said housing to a fill position having said housing a generally horizontal orientation or to a dump position having said housing being tilted rearward from said frame;
a hitch connector being attached to said frame, said hitch connector having a free end positioned distal to said frame and an attached end positioned proximal to said frame, said attached end being positioned nearer to said first lateral side than said second lateral side, said free end being movable laterally away from a longitudinal axis said first lateral side such that said frame is configured to be offset from a trailer hitch pulling said frame;
a rake being pivotally coupled to said frame adjacent to said front side, said rake being configured to engage rocks such that the rocks are moved upwardly into said housing, said rake having a distal end and a proximal end relative to said housing, said rake being positionable in a deployed position being positioned adjacent to or below and engaging the ground surface or in a stored position vertically spaced from the ground surface, said rake including a plurality of spaced plates extending from said proximal end to said distal end, said plates each lying in a vertically oriented plane and being oriented parallel to each other, said distal ends being pointed, said plates each having a bottom surface being convexly arcuate;
a pair of guide walls being attached to said rake, said guide walls being positioned on opposite outer sides of said rake, said guide walls flaring outwardly as said guide walls extend upwardly from said plates;
a lift mechanism being attached to said rake, said lift mechanism being actuated to selectively move said rake between said stored and said deployed positions;
a shovel being rotatably mounted to said rake and being configured to move rocks up said rake and into said housing, said shovel comprising:
an axle being rotatably attached to said rake and traversing an upper surface of said rake;
a paddle arm being attached to said axle, said paddle arm having a pair of opposed ends positioned opposite of each other, each of said opposed ends being movably along said plates as said axle is rotated relative to said rake, said opposed ends being configured to engage rocks and move the rocks along said plates and into said positionable adjacent to said plates as said axle housing;
each of said opposed ends having a plurality of teeth attached thereto;
a drive assembly being mechanically coupled to said shovel and being turned on to rotate said shovel relative to said rake.
